(19) United States
(12) Patent Application Publication
(10) Pub. No.: US 2005/0267733 A1
(43) Pub. Date: Dec. 1, 2005

(54) System and method for a translation process within a development infrastructure

(76) Inventors: Rainer Hueber, Hockenheim (DE); Carlo-Alexander Goetz, Hockenheim (DE); Christian Lieske, Wiesloch (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/858,675

(22) Filed: Jun. 1, 2004

(51) Int. Cl. G06F 17/28

(52) U.S. Cl. 704/2

(57) ABSTRACT

A system and method are provided for a translation data exchange system. In an embodiment, the translation data exchange system receives a release notification from a development environment. The release notification may indicate that one or more source files have been (or are in the process of being) released to a development repository. The translation data exchange system may identify one or more released source files having a single interchange data format. In an embodiment, the identified source files are automatically extracted from the development environment. Each extracted source file may include text to be translated by a translation system.

### TECHNICAL FIELD

Embodiments of the invention generally relate to the field of internationalization of computer software and more particularly, to a system and method for a translation process within a development infrastructure.

### BACKGROUND

In order to take advantage of the global marketplace, computer software (or simply, software) should be “internationalized.” The goal of “internationalization” is to adapt existing software so that it can be used in several languages without changing the underlying source code. A central aspect of internationalization is the translation of texts that are used, for example, to label user interface elements or to display error messages.

FIG. 1 is a block diagram illustrating a conventional software translation system. A developer writes software that includes text (e.g., button labels or error messages). The software is typically encoded according to any of a number of native file formats (e.g., native files 102-108). The developer provides the software to an “internationalization” engineer who prepares the software for translation (or, alternatively, localization tools having built-in filters may be used to prepare the software for translation).

The internationalization engineer uses filters 110-116 to convert the native files 102-108 to a proprietary file format that translation tool 120 can interpret. Since translation tool 120 is designed to work with a proprietary file format it is often called a customer specific translation tool. Translation tool 120 translates text in software from a first language (e.g., German) to a second language (e.g., French).

Although translation tool 120 provides a mechanism to translate text, there are still a number of obstacles in the internationalization process. The typical internationalization project includes data in many different file formats, for example, Java properties, Windows resources, HyerText Markup Language files, a number of proprietary formats, etc. As shown in FIG. 1, separate filters (e.g., filters 110-116) are used to convert each of the file formats into a format that is used in translation tool 120. Each time a new file format is introduced, or when an existing file format is changed, a new filter must be added and/or an existing filter must be changed.

Also, the conventional translation system shown in FIG. 1 does not provide a way to specify a context for the text. The context for text may include, for example, a “locale,” a subject matter domain, the placement of specific text within a larger text, etc. The term “locale” refers to the combination of a language with a country (or region). For example, the version of English that is used in the United States or the version that is used in the United Kingdom.

In addition, conventional localization tools require a significant amount of manual intervention. For example, text files are manually provided to the internationalization engineer. The processes of providing the extracted text files to a translation tool and obtaining translated files from the translation tool are also manually implemented. This manual intervention reduces the efficiency of the translation process and increases the complexity of the process.

### SUMMARY OF THE INVENTION

A system and method are provided for a translation data exchange system. In an embodiment, the translation data exchange system receives a release notification from a development environment. The release notification may indicate that one or more source files have been (or are in the process of being) released to a development repository. The translation data exchange system may identify one or more released source files having a single interchange data format. In an embodiment, the identified source files are automatically extracted from the development environment. Each extracted source file may include text to be translated by a translation system.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating a conventional software translation system.

FIG. 2 is a block diagram illustrating selected elements of an internationalization infrastructure, according to an embodiment of the invention.

FIG. 3 is a block diagram of the basic structure of the single interchange data format, according to an embodiment of the invention.

FIG. 4 is a block diagram of the structure of a header element, according to an embodiment of the invention.

FIG. 5 is a block diagram illustrating the structure of a context element, according to an embodiment of the invention.

FIG. 6 is a block diagram illustrating the structure of a body element, according to an embodiment of the invention.

FIG. 7 is an illustration of a user interface object and selected portions of a corresponding single interchange data format file.

FIG. 8 is a block diagram illustrating selected elements of a translation data exchange system, according to an embodiment of the invention.

FIGS. 9a-9b are flow diagrams illustrating certain aspects of a method for internationalizing software, according to an embodiment of the invention.

FIG. 10 is a block diagram of a computing device implemented according to an embodiment of the invention.

### DETAILED DESCRIPTION

A system and method are provided for a translation data exchange system. In an embodiment, the translation data exchange system receives a release notification from a development environment. The release notification may indicate that one or more source files have been (or are in the process of being) released to a development repository. The translation data exchange system may identify one or more released source files having a single interchange data format. In an embodiment, the identified source files are automatically extracted from the development environment. As is further described below, each extracted source file may include text to be translated by a translation system.

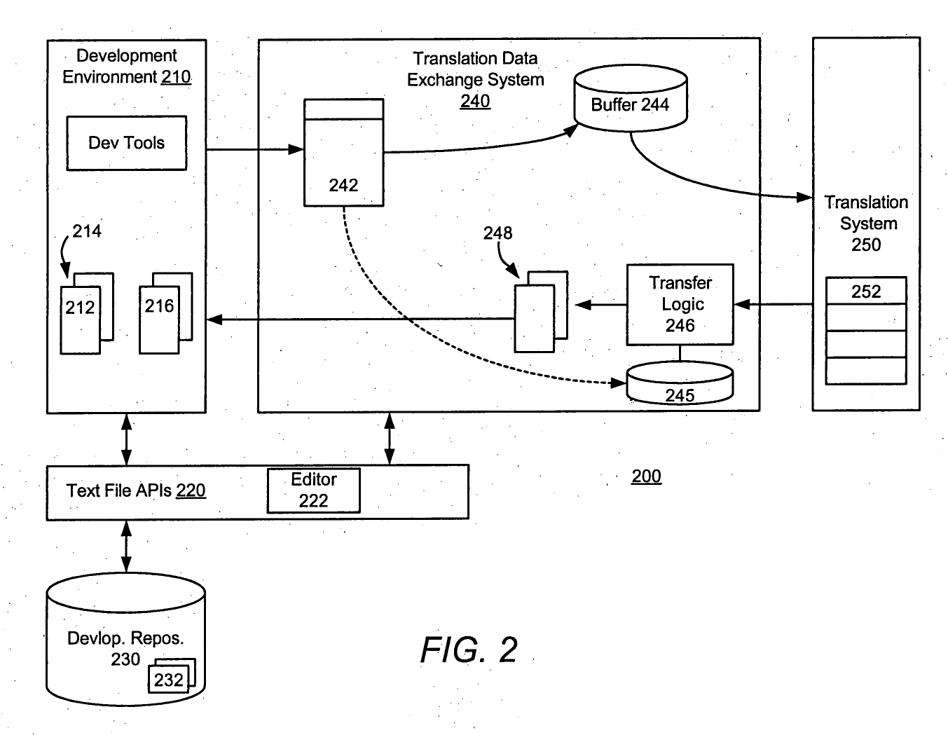

FIG. 2 is a block diagram illustrating selected elements of internationalization infrastructure 200, according to an embodiment of the invention. In an embodiment, internationalization infrastructure 200 adapts computer software so that it can be used in several languages without changing the source code. The software may include text in, for example, user interface elements (e.g., buttons, labels, etc.) and/or error messages. Internationalization infrastructure 200 provides an automated workflow to translate these texts into one or more “target” languages.

Development environment 210 provides a software development environment for writing computer software. In one embodiment, development environment 210 is an implementation of, at least in part, the Eclipse Platform available under the Common Public License from the Eclipse Consortium (www.eclipse.org). In an alternative embodiment, development environment 210 may be a different development environment.

In one embodiment, language-specific text elements are stored separately from source code in property files 212. A collection of property files 212 may form a resource bundle 214. The term “resource bundle” broadly refers to a set of property files containing text elements. In one embodiment, resource bundle 214 is an implementation of the Java class PropertyResourceBundle. Since language-specific text elements are stored separately in property files 212, the source code is not dependent on a particular language.

Each of property files 212 may include text elements in a particular language. At runtime, an application may access the appropriate property file to display text to a user in the particular language. The application may determine which language to display (and, therefore which property file 212 to access) based, at least in part, on a user identifier, user profile, or according to a policy for displaying text in a de fault language. For example, the relevant property files 212 may be loaded dynamically (at runtime) based, at least in part, on a language identifier of the current user.

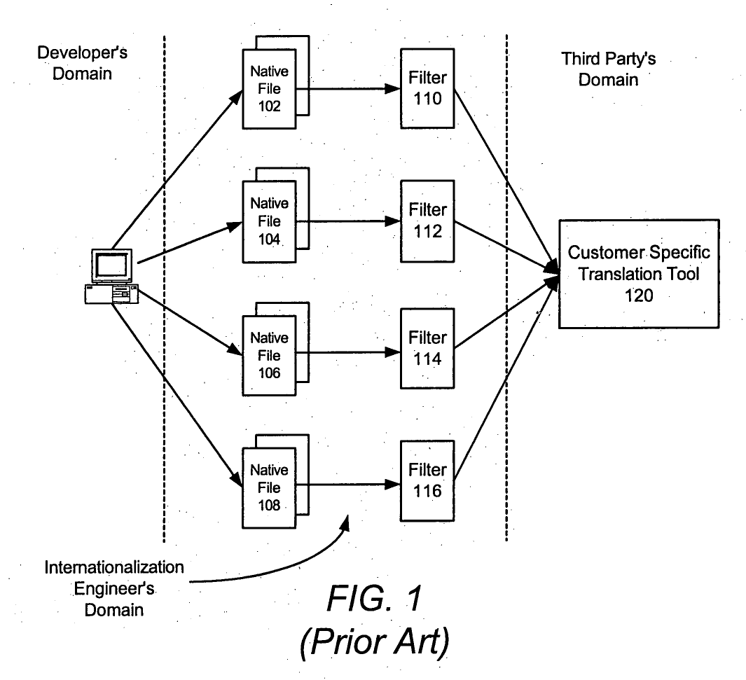

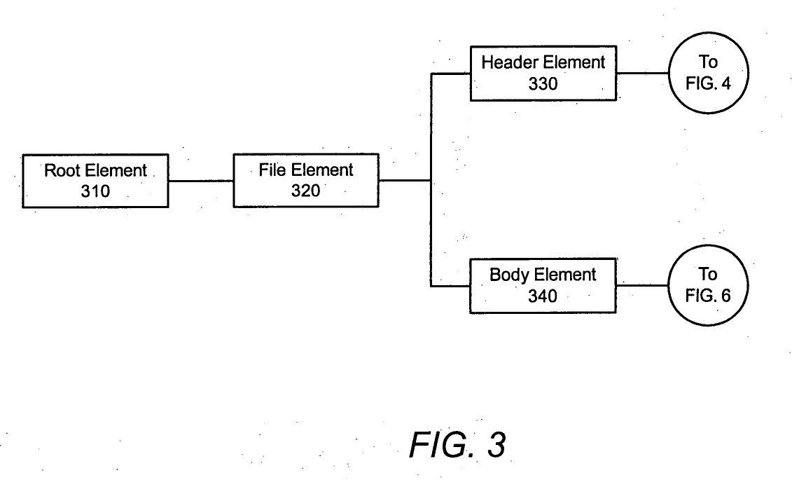

In one embodiment, property files 212 are not translated directly. Instead, they are first converted to a single interchange data format. The single interchange data format serves as an intermediary between the arbitrary native file formats (e.g., property files 212) and the rest of internationalization infrastructure 200. The single interchange data format reduces the complexity and increases the efficiency of internationalization infrastructure 200. For example, there is no need to provide a separate filter (e.g., filters 110-116, as shown in FIG. 1) for each native file format. In addition, the single interchange data format provides a mechanism for specifying a context for text that is translated from one language to another. The single interchange data format is further discussed below with reference to FIGS. 3-6.

Property files 212 may be automatically or manually converted to single interchange data format files (or, for ease of discussion, source files) 216. In an embodiment, development environment 210 automatically passes texts that are written in source code (e.g., labels, error message's, etc.) to property files 212. In addition, text file application program interfaces (APIs) 220 may provide a single interchange data format editor 222 to convert property files 212 to source files 216. In an embodiment, the information within each property file 212 is stored in a particular source file 216.

Development repository 230 is a persistent store for design time objects. In one embodiment, development repository 230 includes a database (or other persistent store) and/or a database management system. In one embodiment, development repository 230 provides an infrastructure for managing distributed and large-scale application development that includes mechanisms to propagate source code changes between two or more repositories.

In an embodiment, development environment 210 periodically sends release notification 242 to translation data exchange system 240. Release notification 242 may be a list of files that have recently been “checked-in” to development repository 230. For example, a component may check development objects 232 (including property files and/or source files) into development repository 230. The term “component” broadly refers to an entity that provides services to another entity. A “development object” broadly refers to a software entity that is being developed. Development objects 232 may be hierarchally organized into one or more folders each having one or more storage locations. Each development object 232 may have a globally unique identifier to specify a storage location to which the object belongs. At least some of the recently checked-in development objects 232 may correspond to a source file 216 that contains language-specific text for the development object. In one embodiment, each source file 216 includes the globally unique identifier of its corresponding development object 232.

In an embodiment, translation data exchange system 240 scans release notification 242 to identify files having the single interchange data format (e.g., source files 216). In one embodiment, translation data exchange system 240 automatically extracts source files 216 from development environment 210 after it identifies the files as having the single interchange data format. The extracted files are buffered in buffer 244. The term “buffer” may refer to a persistent store used to hold data while it is being processed. In one embodiment, the globally unique identifier of each buffered file is stored in persistent store 245 so that the buffered file can be returned to the proper location in development environment 210. In one embodiment, the extracted files are buffered in buffer 244 until translation system 250 requests one or more buffered files.

Translation system 250 is a translation tool that receives information in a source language, translates the received information into one or more target languages, and returns the translated information to, for example, translation data exchange system 240. In one embodiment, translation system 250 is the translation tool that may be available in the Netweaver® platform developed by SAP AG. In an alternative embodiment, a different translation tool may be used.

In one embodiment, translation tool 250 stores translated information in database tables 252. Translation tool 250 may periodically notify translation data exchange system 240 that it is ready to transfer some or all of the translated information stored in database tables 252. In an embodiment, transfer logic 246 receives the translated information from database tables 252 and organizes it into translated files 248. In one embodiment, there is a separate translated file 248 for each distinct language. For example, if a given source file 216 is translated into three languages, then there may be three separate translated files 248 corresponding to the source file 216.

Transfer logic 246 may automatically return translated files 248 to development repository 230. In one embodiment, transfer logic 246 uses the globally unique identifiers stored in persistent store 245 to determine the proper folder and storage location to which translated files 248 are returned. In an alternative embodiment, logic within development environment 210 and/or development repository 230 ensures that translated files 248 are persistently stored in the proper location.

FIG. 3 is a block diagram of the basic structure of the single interchange data format, according to an embodiment of the invention. In one embodiment, the single interchange data format is an extensible Markup Language (XML) application. An XML application refers to an application that is based, at least in part, on one of the XML standards, for example, the XML standard promulgated by the World Wide Web Consortium (W3C) entitled, “Extensible Markup Language (XML) 1.0 (Second Edition),” 6 Oct. 2000 (hereinafter, the XML Standard). In an embodiment, the single interchange data format is related to the XML Localization Interchange File Format (XLIFF; see “XLIFF 1.1 Specification,” October 2003). In an alternative embodiment, the single interchange data format may be based on a different language (e.g., a different markup language).

Root element 310 encloses a file that is implemented according to the single interchange data format. In an embodiment, file element 320 corresponds to a single file in the original native format (e.g., a single Java properties file). File element 320 includes header element 330 and body element 340. In an embodiment, header element 330 contains metadata that pertains to all of the localizable objects contained in body element 340. The term “localizable object” refers to language-specific text and may also include other items such as graphics, sounds, etc. that have different formats or follow different schemes in different locales. Body element 340 contains one or more localizable objects (e.g., from a Java property file).

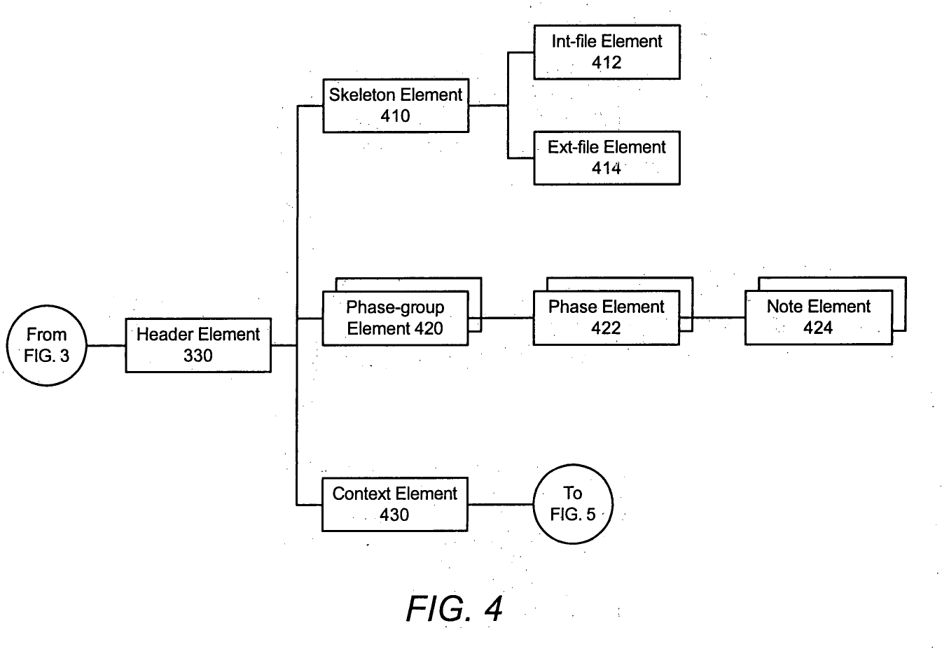

FIG. 4 is a block diagram of the structure of header element 330, according to an embodiment of the invention. Header element 330 includes skeleton element 410, phase-group element 420, and context element 430. Skeleton element 410 may contain a “skeleton” of a source file (e.g., source file 216, shown in FIG. 2) and/or a reference to a location where the skeleton is located. The term “skeleton” refers to a means by which non-localizable content may be separated from (and merged with) translated files. Internal file element 412 may contain the skeleton and external file 414 may contain a reference to the location where the skeleton is stored.

Each header element 330 may include one or more phase-group elements 420. Phase-group element 420 may contain information that pertains generally to the processing phases used to internationalize the file. Each phase element 422 may provide information about a specific processing phase such as identifying the tool that generated a source file (e.g., source file 216, shown in FIG. 2). Each phase element 422 may have one or more note elements 424. Note element 424 may contain notes regarding a processing phase such as the version of a tool that generated the source file.

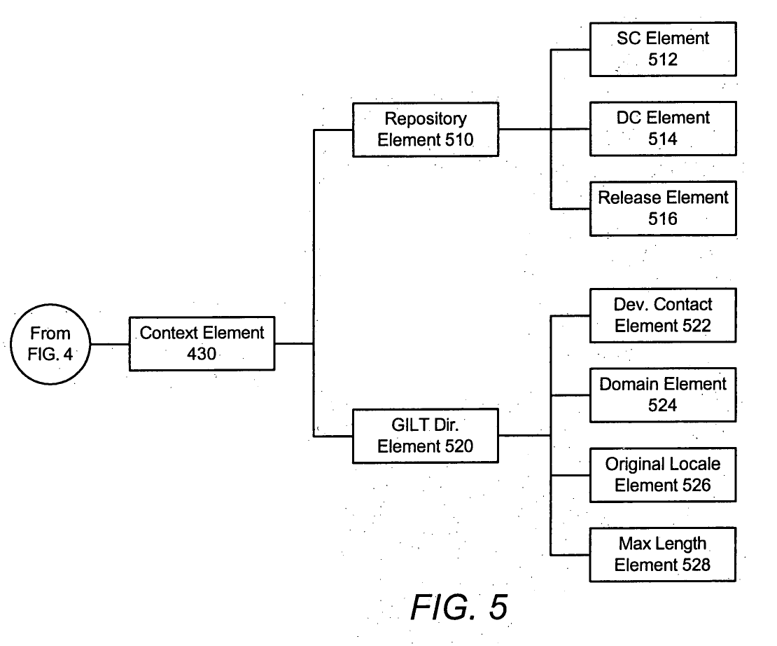

Context element 430 may contain information that improves the internationalization of the localizable objects stored in body element 340 by providing descriptive information that is accessible by a translation system (e.g., translation system 250, shown in FIG. 2). FIG. 5 is a block diagram illustrating the structure of context element 430, according to an embodiment of the invention. Context element 430 may include repository element 510 and Globalization, Internationalization, Localization, and Translation (GILT) directives element 520.

In an embodiment, repository element 510 contains information about the development repository (e.g., development repository 230, shown in FIG. 2) in which the source file and/or its corresponding development object is stored. In one embodiment, development objects are composed of development components and software components. A “development component” is a reusable container for arbitrary development entities and produced entities. Development entities may include, for example, Java source files, table definitions, database content, Java Server Page (JSP) pages, and the like. Produced entities may include, for example, Java class files, libraries, deployable archives, and the like. A “software component” is a set of related development components that may constitute a deliverable unit of software.

As shown in FIG. 5, repository element 510 may include software component element 512, development component element 514, and release element 516. Software component element 512 may contain information about the software component to which the source file belongs. Similarly, development component element 514 may include information about the development component to which the source file belongs. Release element 516 may specify to which release of a software entity the source file belongs.

In an embodiment, GILT directives element 520 provides contextual information for use by an internationalization infrastructure (e.g., internationalization infrastructure 200, shown in FIG. 2). In the illustrated embodiment, GILT directives element 520 includes development contact element 522, domain element 524, original locale element 526, and maximum length element 528. In one embodiment, development contact element 522 contains contact information (e.g., an email address) for the last developer to work on the source file. Domain element 524 may include subject matter domain information to provide a subject matter context for the localizable object(s) in body element 340. For example, if the localizable objects pertain to software used by a financial institution, then domain element 524 may include the initials FI to designate the subject matter domain of financial institutions.

Original locale element 526 may contain information about the original locale of the source file. For example, if the source file is from software written for English as it is used in the United States, then original locale element 526 may include the initials EN-us. A translation system (e.g., translation system 250, shown in FIG. 2) may more efficiently translate the localizable objects in body element 340 if it can determine an original locale for the localizable objects. Max length element 528 may specify the maximum length for certain types of localizable objects. For example, the maximum length of text string for a label may be different than the maximum length of a text string for an error message.

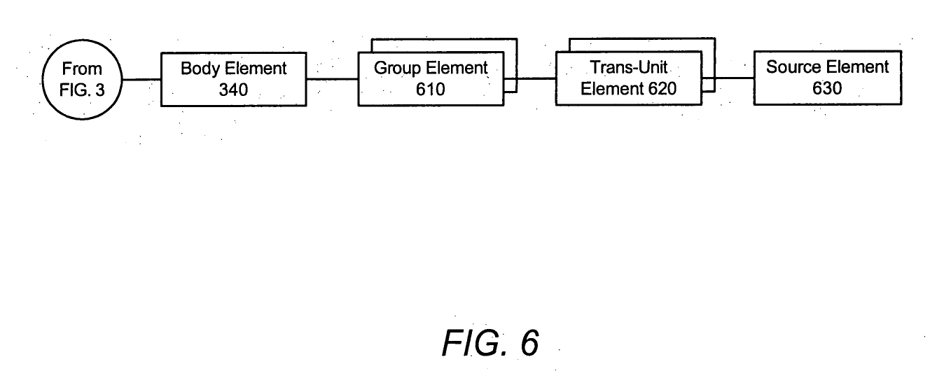

FIG. 6 is a block diagram illustrating the structure of body element 340, according to an embodiment of the invention. Body element 340 contains the localizable objects of a text file (e.g., a Java properties file). The illustrated embodiment of body element 340 includes group element 610, translation unit element 620, and source element 630.

Each body element 340 may contain one or more group elements 610. Group elements 610 may be used to organize localizable objects according to resource type. The term “resource type” refers to whether a localizable object pertains to, for example, a button, label, error message, etc. In one embodiment, if the single interchange data format file contains localizable objects of different resource types then there is a separate group element 610 for each of those resource types.

Each group element 610 may contain one or more translation unit elements 620. Each translation unit element 620 may contain a source element 630 and metadata about the source element 630. In an embodiment, source element 630 contains a single localizable object (e.g., text that appears on a button in a user interface). The metadata contained in translation unit element 620 pertains to the single localizable object (e.g., an identifier for the button).

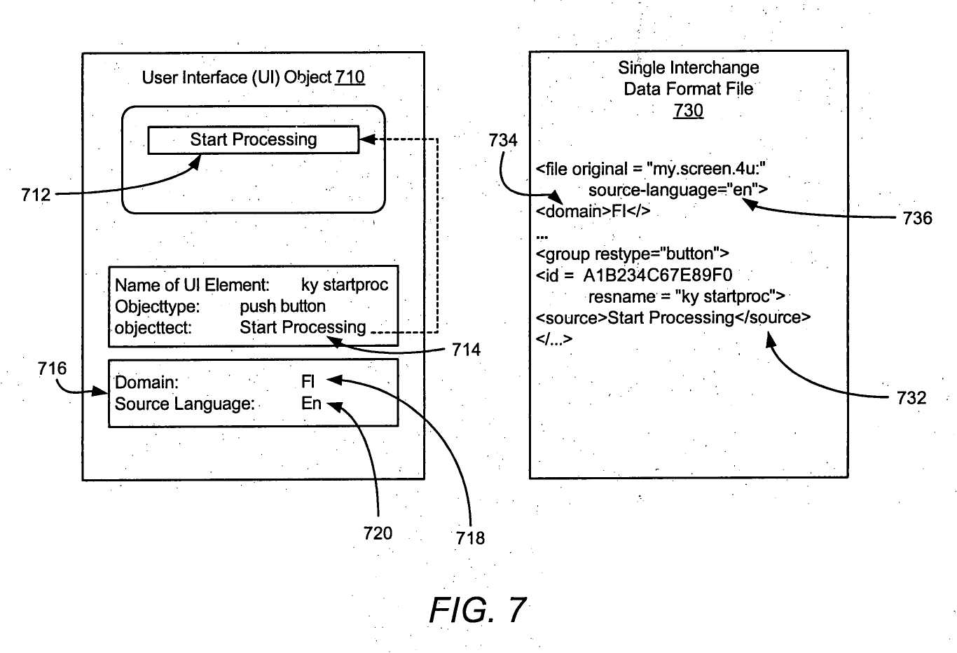

FIG. 7 is an illustration of a user interface object 710 and selected portions of a corresponding single interchange data format file 730. User interface object 710 provides button 712 that includes language-specific text 714. User interface object 710 also includes context information 716 to improve the language translation of text 714. Context information 716 may be automatically generated by a development environment (e.g., development environment 210, shown in FIG. 2) and/or manually generated by a developer (e.g., during design time using text file APIs 220, shown in FIG. 2). In the illustrated embodiment, context information 716 includes subject matter domain 718 (e.g., FI) and source language 720 (e.g., En).

Single interchange data format file 730 contains one or more localizable elements of UI object 710. In addition, file 730 contains metadata about the localizable elements to provide a context for the elements during the translation process. Source element 732 contains the localizable element of UI 710 (e.g., text 714). Subject matter domain element 734 contains subject matter domain 718 (e.g., FI). In the illustrated embodiment, source language 720 is defined as an attribute of file 730 as shown by reference number 736. Alternatively, file 730 may include an original locale element (e.g., original locale element 526, shown in FIG. 5) to contain source language 720.

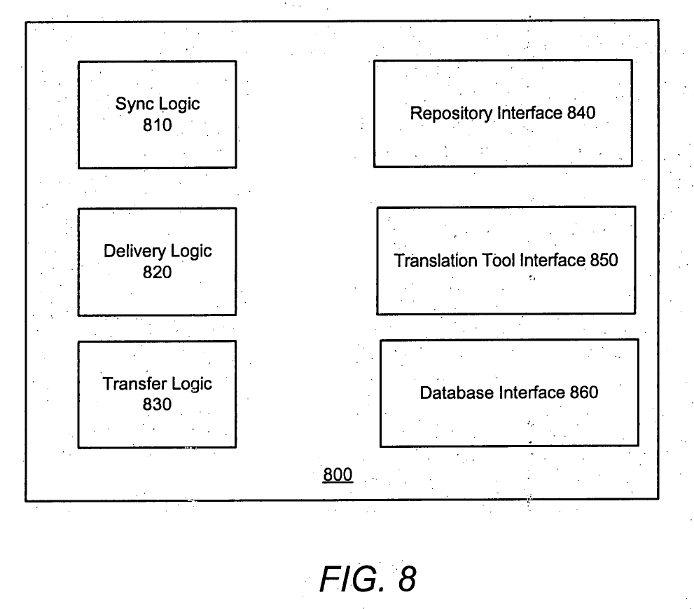

FIG. 8 is a block diagram illustrating selected elements of translation data exchange system 800, according to an embodiment of the invention. In the illustrated embodiment, translation data exchange system 800 includes synchronization logic 810, delivery logic 820, transfer logic 830, repository interface 840, translation tool interface 850, and database interface 860. In an alternative embodiment of the invention, translation data exchange system 800 may include more elements, fewer elements, and/or different elements.

In an embodiment, synchronization logic 810 uses repository interface 840 to “synchronize” with a development environment (e.g., development environment 210, shown in FIG. 2) and to obtain one or more source files (e.g., source files 216, shown in FIG. 2) form the development environment. Synchronization logic 810 may receive a release notification from the development environment (and/or a service employed by the development environment). In one embodiment the release notification includes a list of new/changed development objects (including files) some of which are structured according to the single interchange data format discussed above with reference to FIGS. 3-7. Synchronization logic 810 may identify the listed files having the format and then synchronize with a development repository (e.g., development repository 230, shown in FIG. 2) to obtain the files (e.g., source files 216, shown in FIG. 2). In one embodiment, synchronization logic 810 automatically identifies the listed objects having the format and then automatically obtains them from the development repository, responsive to receiving the release notification. The files may be buffered until a translation system requests them (e.g. translation system 250, shown in FIG. 2).

In an embodiment, delivery logic 820 provides buffered files to the translation system (e.g., via translation tool interface 850) in response to receiving a request for one or more buffered files. In an alternative embodiment, delivery logic 820 may periodically poll the translation system to determine whether it is ready to receive one or more buffered files. The received request may include parameters that specify a selected subset of the buffered files. For example, the received request may specify that all files buffered after a given time and/or all buffered files pertaining to a specific resource type be delivered to the translation system. Delivery logic 820 may receive the request, parse it to obtain the parameters, and scan the buffer to locate the requested files. Once the requested files are located, delivery logic 820 may provide them to the translation system.

In an embodiment, transfer logic 830 receives translated information from the translation system, creates one or more translated files from the received translation information, and persistently stores the translated files in, for example, the development repository. The translation system may send transfer logic 830 a list of translated file names corresponding to one or more translated files that are being stored in the translation system (e.g., stored in database tables). Transfer logic 830 may access the database tables to obtain the translated files. The translated files may be sorted according to the repository from which the corresponding source files were obtained. In an embodiment, transfer logic 830 uses a globally unique identifier obtained from each source file to map the translated files to the proper repository. The globally unique identifiers may be stored in a database and accessed via database interface 860. Transfer logic 830 may then store the translated files in the appropriate repositories.

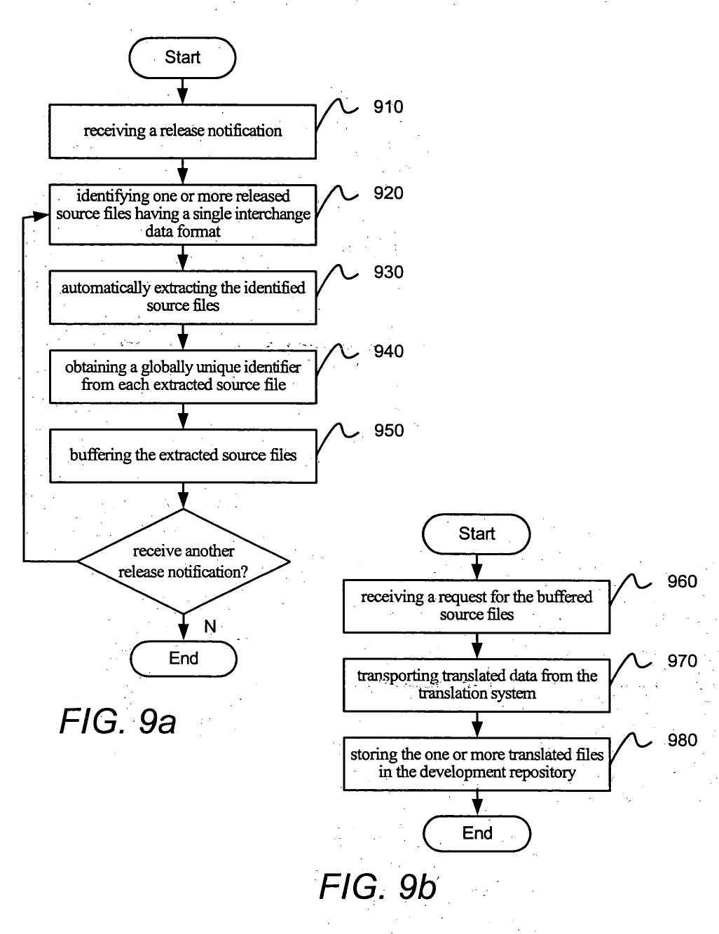

Turning now to FIGS. 9a-9b, the particular methods associated with embodiments of the invention are described in terms of computer software and hardware with reference to a flowchart. The methods to be performed by a translation data exchange system may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 9a is a flow diagram illustrating certain aspects of a method for internationalizing software, according to an embodiment of the invention. Referring to process block 910, a translation data exchange system (e.g., translation data exchange system 240, shown in FIG. 2) receives a release notification from a development environment (e.g., development environment 210, shown in FIG. 2). The release notification may include a list of files (e.g., a release list) and some of the listed files may have a file extension indicating they are single interchange data format files. Referring to process block 920, the translation data exchange system may scan the release list to identify one or more released files having the single interchange data format.

Referring to process block 930, the translation data exchange system may automatically extract the identified files from the development environment (or, more specifically, from the development repository). The term “automatically extract” refers to obtaining the identified files in response to receiving the release notification. Each extracted file may contain a globally unique identifier (GUID) that specifies its proper location within the development repository. In an embodiment, the extracted file may also include a GUID that specifies the development repository to which the file should be returned. Referring to process block 940, the translation data exchange system obtains the GUID from each extracted file and stores it, for example, in a database. The translation data exchange system may use the GUID to track the proper repository locations for extracted files so that each extracted file may be returned to its proper location in the development repository. Referring to process block 950, the translation data exchange system buffers the extracted files (e.g., in buffer 244, shown in FIG. 2).

FIG. 9b is a flow diagram illustrating certain aspects of a method for internationalizing software, according to an embodiment of the invention. Referring to process block 960, the translation data exchange system receives a request from a translation system (e.g., translation system 250, shown in FIG. 2) for at least some of the buffered files. The request may specify a selected subset of the buffered files or may simply request all buffered files. The translation data exchange system may transfer the requested files to the translation system as shown by reference number 970.

The translation system translates the transferred files into one or more different languages. In an embodiment, the translation system interprets context information (e.g., stored in markup language tags of the single interchange data format files) contained in the files to simplify and enhance the translation process. For example, the transferred files may include an original locale element to specify a language and country of origin for the text in the file. The translation system may use the original locale element to control workflow while processing the file. Similarly, the transferred files may include information that specifies a subject matter domain that pertains to the text. The translation system translates the files and notifies the translation data exchange system when the files are translated.

Referring to process block 980, the translation data exchange system receives the translated files (or, more specifically, receives the translated information and organizes it into translated files). In an embodiment, the translation data exchange system automatically stores the translated files in the development repository. If there is more than one development repository, then the translation data exchange system may automatically store the translated files in the proper development repository. The term “automatically stores” refers to persistently storing the translated objects in response to receiving them from the translation system. In one embodiment, the translation data exchange system uses the GUIDs obtained from the source files to determine the proper storage location for the translated files.

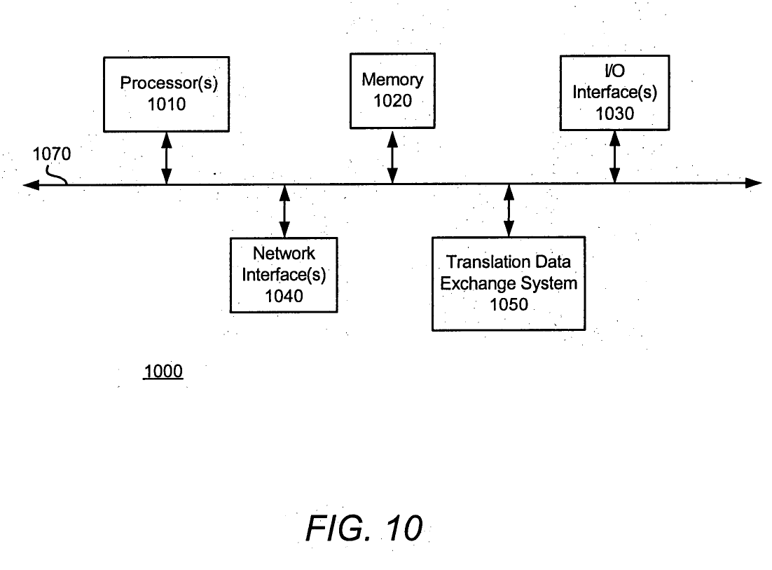

FIG. 10 is a block diagram of computing device 1000 implemented according to an embodiment of the invention. Computing device 1000 may include: processor(s) 1010, memory 1020, one or more Input/Output interfaces 1030, network interface(s) 1040, and translation data exchange system 1050. The illustrated elements may be connected together through system interconnection 1070. Processor(s) 1010 may include a microprocessor, microcontroller, field programmable gate array (FPGA), application specific integrated circuit (ASIC), central processing unit (CPU), programmable logic device (PLD), and similar devices that access instructions from system storage (e.g., memory 1020), decode them, and execute those instructions by performing arithmetic and logical operations.

Translation data exchange system 1050 enables computing device 1000 to automatically extract source files, provide them to a translation system, and/or persistently store translated files. Translation data exchange system 1050 may be executable content, control logic (e.g., ASIC, PLD, FPGA, etc.), firmware, or some combination thereof, in an embodiment of the invention. In embodiments of the invention in which translation data exchange system 1050 is executable content, it may be stored in memory 1020 and executed by processor(s) 1010.

Memory 1020 may encompass a wide variety of memory devices including read-only memory (ROM), erasable programmable read-only memory (EPROM), electrically erasable programmable read-only memory (EEPROM), random access memory (RAM), non-volatile random access memory (NVRAM), cache memory, flash memory, and other memory devices. Memory 1020 may also include one or more hard disks, floppy disks, ZIP disks, compact disks (e.g., CD-ROM), digital versatile/video disks (DVD), magnetic random access memory (MRAM) devices, and other system-readable media that store instructions and/or data. Memory 1020 may store program modules such as routines, programs, objects, images, data structures, program data, and other program modules that perform particular tasks or implement particular abstract data types that facilitate system use.

One or more I/O interfaces 1030 may include a hard disk drive interface, a magnetic disk drive interface, an optical drive interface, a parallel port, serial controller or super I/O controller, serial port, universal serial bus (USB) port, a display device interface (e.g., video adapter), a network interface card (NIC), a sound card, modem, and the like. System interconnection 1070 permits communication between the various elements of computing device 1000. System interconnection 1070 may include a wide variety of signal lines including one or more of a memory bus, peripheral bus, local bus, host bus, bridge, optical, electrical, acoustical, and other propagated signal lines.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

1. A method employed within a network comprising:
receiving a release notification from a development environment, the release notification indicating one or more source files are released to a development repository;
identifying one or more released source files having a single interchange data format;
automatically extracting the identified source files having the single interchange data format from the development repository, each identified source file having text to be translated;
buffering the extracted source files in a buffer; and
receiving a request for the buffered source files from a translation system.

2. The method of claim 1, further comprising:
obtaining a globally unique identifier from each extracted source file, the globally unique identifier to specify a location in the development repository from which a source file was extracted.

3. The method of claim 1, wherein identifying one or more released source files having a single interchange data format comprises:
scanning a release list to identify one or more released source files having the single interchange data format.

4. The method of claim 1, wherein each extracted source file includes subject matter domain information to specify a subject matter domain for the associated text.

5. The method of claim 1, wherein each extracted source file includes source file grouping information to indicate whether two or more localizable objects are to be grouped according to resource type.

6. The method of claim 1, wherein each extracted source file includes locale information to specify a local language for the associated text.

7. The method of claim 1, wherein the single interchange data format is an extensible Markup Language (XML)-based data format.

8. The method of claim 1, further comprising:
receiving an indication from the translation system that translated data is available;
transporting the translated data from the translation system to a translation exchange system, responsive to receiving the indication; and
creating one or more translated files based, at least in part, on the translated data, each translated file corresponding to one of the extracted source files.

9. The method of claim 8, further comprising:
storing the one or more translated files in the development repository, wherein the storage location of each translated file is based, at least in part, on the globally unique identifier of a corresponding source file.

10. The method of claim 1, wherein receiving the request for the buffered source files from a translation system comprises:
receiving a request for a specified subset of the buffered source files.

11. The method of claim 1, wherein the one or more source files are one or more Java files.

12. A system for managing translation data exchange comprising:
synchronization logic to identify one or more source files having a single interchange data format;
a development repository interface to automatically extract the one or more identified source files from a development repository, each extracted source file having text to be translated, and to buffer the one or more extracted source files in a buffer; and
a database interface to store a globally unique identifier for each extracted source file in a database.

13. The system of claim 12, further comprising:
delivery logic to automatically provide the one or more buffered source files to a translation system responsive to receiving a request for the buffered source files from the translation system.

14. The system of claim 13, further comprising:
transfer logic to receive translated files from the translation system, each translated file corresponding to a source file extracted from the development repository, and to automatically store the translated files in the development repository, wherein the storage location of each translated file is based, at least in part, on a globally unique identifier of the corresponding source file.

15. The system of claim 14, wherein the single interchange data format is an extensible Markup Language (XML) based data format.

16. The system of claim 15, wherein the one or more source files are Java files.

17. A system comprising:
means for receiving a release notification from a development environment, the release notification indicating one or more source files are released to a development repository;
means for identifying one or more released source files having a single interchange data format;
means for automatically extracting the identified source files having the single interchange data format from the development repository, each identified source file having text to be translated;
means for buffering the extracted source files in a buffer; and
means for receiving a request for the buffered source files from a translation system.

18. The system of claim 17, further comprising:
means for obtaining a globally unique identifier from each extracted source file, the globally unique identifier to specify a location in the development repository from which a source file was extracted.

19. The system of claim 17, wherein each extracted source file includes subject matter domain information to specify a subject matter domain for the associated text.

20. The system of claim 17, wherein each extracted source file includes source file grouping information to indicate whether two or more localizable objects are to be grouped according to resource type.

21. The system of claim 17, wherein each extracted source file includes locale information to specify a local language for the associated text.

22. The system of claim 17, further comprising:
means for receiving an indication from the translation system that translated data is available;
means for transporting the translated data from the translation system to a translation exchange system, responsive to receiving the indication; and
means for creating one or more translated files based, at least in part, on the translated data, each translated file corresponding to one of the extracted source files.

23. The system of claim 22, further comprising:
means for storing the one or more translated files in the development repository, wherein the storage location of each translated file is based, at least in part, on the globally unique identifier of a corresponding source file.

24. An article of manufacture comprising:
an electronically accessible medium providing instructions that, when executed by an apparatus, cause the apparatus to
receive a release notification from a development environment, the release notification indicating one or more source files are released to a development repository;
identify one or more released source files having a single interchange data format;
automatically extract the identified source files having the single interchange data format from the development repository, each identified source file having text to be translated;
buffer the extracted source files in a buffer; and
receive a request for the buffered source files from a translation system.

25. The article of manufacture of claim 24, wherein the electronically accessible medium provides further instructions that, when executed by the apparatus, cause the apparatus to
obtain a globally unique identifier from each extracted source file; the globally unique identifier to specify a location in the development repository from which a source file was extracted.

26. The article of manufacture of claim 24, wherein each extracted source file includes subject matter domain information to specify a subject matter domain for the associated text.

27. The article of manufacture of claim 24, wherein each extracted source file includes source file grouping information to indicate whether two or more localizable objects are to be grouped according to resource type.

28. The article of manufacture of claim 24, wherein each extracted source file includes locale information to specify a local language for the associated text.

29. The article of manufacture of claim 24, wherein the electronically accessible medium provides further instructions that, when executed by the apparatus, cause the apparatus to
receive an indication from the translation system that translated data is available;
transport the translated data from the translation system to a translation exchange system, responsive to receiving the indication; and
create one or more translated files based, at least in part, on the translated data, each translated file corresponding to one of the extracted source files

30. The article of manufacture of claim 24, wherein the electronically accessible medium provides further instructions that, when executed by the apparatus, cause the apparatus to
store the one or more translated files in the development repository, wherein the storage location of each translated file is based, at least in part, on the globally unique identifier of a corresponding source file.
